(19) United States
(12) Patent Application Publication
(10) Pub. No.: US 2024/0127328 A1
(43) Pub. Date: Apr. 18, 2024

(54) ENHANCED ARTICLES EMBEDDED WITH SPORTS ARTIFACTS

(71) Applicant: David Bunnell, Georgetown, TX (US)

(72) Inventor: David Bunnell, Georgetown, TX (US)

(21) Appl. No.: 18/212,664

(22) Filed: Jun. 21, 2023

Related U.S. Application Data
(60) Provisional application No. 63/392,465, filed on Jul. 26, 2022.
(60) Provisional application No. 63/462,199, filed on Apr. 26, 2023.

(51) Int. Cl. G06Q 30/08; G06Q 30/018

(52) U.S. Cl. CPC G06Q 30/08; G06Q 30/018

(57) ABSTRACT

Disclosed herein are enhanced articles of sale which contain sports and entertainment artifacts which refer to an array of items or fixtures that maintains significance because of its presence or use in a cultural event or moment; for example, a sports game or series, concert, award ceremony, show, entertainment venue or any other memorable, culturally relevant instance that is preserved. These artifacts can be affixed to apparel such as caps, hats, scarves, tee shirts, hoodies, sweat pants, socks, footwear etc., in wall hangings or shelf memorabilia such as artwork, baseball cards, any trading cards, pictures, lithographs, autographs, statues, bobbleheads, plaques, etc., and instruments or game devices, such as bats, balls, sticks, rackets, clubs, gloves, drumsticks, etc. When a consumer purchases an enhanced article, they are given a certificate of authenticity that may be registered on an online database which allows a consumer to view all present and former interactions with their purchased product. Consumers may also buy, trade, sell, and view the metadata of their enhanced article of sale and monitor its valuations.

### CROSS REFERENCE TO RELATED APPLICATIONS

This application claims the benefit of U.S. Provisional Patent Application Ser. No. 63/392,465, filed Jul. 26, 2022, and U.S. Provisional Patent Application Ser. No. 63/462,199, filed Apr. 26, 2023, the contents of which are incorporated herein by reference.

### BACKGROUND OF THE INVENTION

Trading cards is a popular hobby and depending on the rarity of an authentic card, it can be an immensely lucrative one as well. Various collectors are willing to spend hundreds of dollars on rare cards, sports and entertainment memorabilia, sports and entertainment artifacts, and cards which feature sports artifacts. Typically, a trading card is printed on paper stock. Such a card may then be framed, and then converted into a wall hanging memorabilia. Or, the trading cards may be stored in protective cases, and held by their owner, traded, or even sold for a profit. Other forms of sports memorabilia may include garments such as jerseys, caps, hoodies, sweatpants and the like. In the case where the sports jersey was an actual jersey worn at a real event such as a baseball game, a worn or used jersey may be framed and then sold.

For the purposes of the background of the present invention, the terminology of articles may include mainly wearables such as actual wall hanging or shelved memorabilia (plaques, statues, bobbleheads, etc.), or actual articles used to play a game (baseball bat, hockey stick, football, etc.). Also, for the purposes of the present invention, assume that artifacts refer to actual pieces of matter (or even entire artifacts in the whole) that may be embedded into articles. For the purposes of the present invention description, an “enhanced” article is an article which includes some artifact or some piece of a sports or entertainment artifact.

When an entertainment or sporting artifact is affixed, embedded, or otherwise incorporated into an article, it creates an enhanced article of sale. The present invention provides an additional layer of authentication that corresponds with the original artifact, thereby creating an “enhanced article”. The original artifact also maintains a serial number, unique asset ID and/or an XofX number that corresponds with the artifact that is embedded or affixed to or within the sale article. Additionally, these enhanced articles also share a unique non-fungible token or NFT that can be transferred to virtual worlds.

Sometimes, the articles can have minuscule pieces of athletic wear such as jerseys, hats, or shavings and pieces of game used equipment such as balls, clothing items, or they may feature signatures, autographs, tickets, benches, or any desired item or piece that can be incorporated. By way of example: an article may be an aluminum baseball bat to be sold to a Little League player, wherein said bat is enhanced with splinters from an actual, used Derek Jeter wooden baseball bat, so that the enhanced article for resale is the aluminum baseball bat containing the precious splinters (or, the artifacts). In another variation, a LeBron James jersey may be sold as the article, but woven into that jersey (the article) will be an artifact, which is a piece of a net from a given game that LeBron James played in (e.g., an NBA championship game), so that the enhanced article is the LeBron James jersey with the precious artifact woven into it being a certain piece of a net from a certain important game.

In another example, an article such as a drumstick or drum kit will have a sliver of an artifact belonging to David Grohl, such as a piece of his used, old, or worn drumsticks and drum kit. Or, a shirt worn by Mick Jagger can be sewn into other types of apparel and articles for his solo work or The Rolling Stones. In various embodiments, an article or artifact can be a piece from a notable cultural event or a celebrity-worn garment, totem, instrument, or piece.

The present invention seeks to infix artifacts in other articles, by way of example and not by way of limitation, into apparel such as caps, hats, scarves, tee shirts, hoodies, sweat pants, socks, footwear, visors, shin guards, boots, etc., in wall hangings or shelf memorabilia such as art work, baseball cards, any trading cards, pictures, lithographs, autographs, statues, bobbleheads, plaques, etc., and game devices or instruments, such as bats, balls, sticks, rackets, clubs, gloves, drumsticks, etc. This process turns a simple article into an enhanced article, equipped with an artifact. The value of these enhanced articles in some instances correspond with their rarity, and in turn, require licensing, certification, and other measures to ensure their authenticity.

The present invention relates to a system and method for creating enhanced articles such as apparel, memorabilia, and sporting or performance equipment by infixing artifacts within articles. These artifacts include things such as game-used equipment, and or used pieces of equipment and apparatuses from a gaming, sporting or entertainment event, or even wooden baseball seats from decommissioned stadiums. The present invention also pertains to the construction of an online marketplace wherein consumers can trade these enhanced articles containing artifacts. This is all executed through a process which monitors and tracks each individual enhanced article containing an artifact to ensure authenticity, which is a concern for sports hobbyists and collectors. In many examples, inauthentic and disingenuous artifacts can find themselves in circulation within the market; by having a database wherein individuals can register their articles of sale within an online marketplace, the issue of inauthenticity is challenged and remedied at the source.

### SUMMARY OF INVENTION

The present invention relates to artifacts infixed within an article, thereby creating an enhanced article.

When a piece of a sporting or entertainment artifact is incorporated into an article and creates an enhanced article of sale, it consequently requires an additional layer of authentication that corroborates with the original authentic artifact (OAA). In other words, the enhanced article is further embedded or affixed with a serial number which correlates with a certificate of authenticity as to both the article and the artifact, and also correlates to ownership records, either via a database or blockchain configuration, which in turn will permit NFT (non-fungible tokenization) of the enhanced articles for facilitating trading and e-commerce.

One type of article includes wearables such as jerseys, mittens, shoulder pads, shorts, shoes, socks, skirts, aps, blazers, headbands, whistles, towels, sweatpants, rings, bracelets, wristbands, blouses, rims, spikes, shooting sleeves, cleats, gloves, mitts, trousers, sunglasses, sweatshirts, batting gloves, raglans, tennis skirts, polos, coats, puffers, button ups, hats, pinnies, visors, molded grips belts, vests, bags, wetsuits, shin guards, mouth guards, neck guards, wrist guards, sweaters, hockey sweaters, boots, tights, crewnecks, helmets, elbow pads, robes, suspenders, handkerchiefs, hairclips, bangles, bodysuits, leotards, capes, masks, skates, frocks, tracksuits, trackpants, scarves, racerback tops, tank tops, crop tops, headbands, jumpsuits, studs, brooches, leggings, phone cases, maillots, sashes, canvas totes, purses, belt bags, neckties, pins, ascots, earrings, chokers, wrist cuffs, ankle braces, thigh pads, crew uniforms, chaps, slacks, rompers, halter tops, body jewelry, necklace, watches, anklets, sports bras, pants, etc.

Another type of article comprises of but does not limit itself to mounted or artistic memorabilia such as art, cases, photographs, videos, books, trading cards, playing cards, cards, buttons, brooches, handbags, sneakers, patches, coins, rods, ribbons, stamps, greeting cards, posters, bobbleheads, dolls, etchings, catalogs, sculptures, chewing gum, action figures, car figures, vinyl records, t-shirts, jerseys, stationary, stickers, spoons, keychains, steins, comic books, hair, foam fingers, benches, frames, tickets, plaques, pictures, bases, plates, cups, dining sets, kitchen appliances, home décor, medallions, trophies, rings, manifestos, gamebooks, playbooks, rules, bats, gloves, pitching charts, rackets, mallets, hoops, balls, footballs, soccer balls, golf balls, pucks, gloves, reels, birdies, belts, slacks, frames, lithographs, autographs, bobbleheads, statues, wall hangings, wreaths, threads, writing instruments, clubs, stadium seats, turf, figurines, nets, programs, food wrappers, soundtracks, rosters, beer mugs, shot glasses, neck pieces, cans, swingmans, tablets, panels, nameplates, car plates, car decor etc. Because some pieces considered memorabilia are replicas, the term artifact here creates a distinction between game used equipment, cultural iconography or memorabilia, celebrity worn items, mementos and items and replicated or emulated items. For example, a plaque bearing a photo of the New England Patriots commemorating their win in the 49^{th} Super Bowl with a replica ticket is an article considered memorabilia. However, if the plaque featured an authentic, verified ticket from the 49^{th} Super Bowl, it would contain a sports artifact, thereby enhancing the article and graduating it from typical article to an enhanced article.

Lastly, another type of article references game devices and instruments, such as but not limited to footballs, football helmets, visors, jerseys, hats, shoulder pads, mouthguards, wrist guards, hockey sticks, helmets, cleats, spikes, cricket bats, mallets, golf clubs, golf balls, golf cases, golf caps, shin guards, hockey helmets, hockey masks, protective gear, baseball gloves, baseball mitts, baseball bats, baseballs, baseball plates, flags, turf, scrap metal, metal scraps, golf gloves, boxing gloves, shorts, tracksuits, javelins, shotputs, pinnies, whistles, wheels, basketball nets, lacrosse sticks, lacrosse helmets, stickballs, pucks, posts, goals, goal posts, racquets, skates, boards, wetsuits, cones, bases, thigh pads, towels, caps, tape, masks, swingmans, soccer ball, Birdies, tennis rackets, surfboards, skateboards, sleds, skis, snowboards, nets, goal netting, game socks, baseball hats, headband, shoes, sneakers, equipment bags, hockey gloves, mittens, tees, divot tools, basketballs, swim caps, swimsuits, pom poms, controllers, goggles, rugby balls, volleyballs, bases, elbow pads, neck guards, water bottles, squash balls, paddles, bridles, breastplates, discs, chaps, saddles, equine gear, lead ropes, spurs, boots, batting helmets, bails, drumsticks, guitars, and musical instruments, among others.

An article becomes an “enhanced” article once an authentic artifact is infixed into it. An artifact refers to an array of items or fixtures that maintains significance because of its presence or use in a cultural event or moment; by way of example and not limitation, a sports game or series, concert, award ceremony, show, entertainment venue or any other memorable, culturally relevant instance that is preserved. Some examples of artifacts include stadium pieces, tickets, artificial turf, used basketball nets, used baseballs, used baseball bats, game footballs, used tights, stadium pieces, stands, old golf balls from tournaments, worn out golf clubs, baseball gloves, worn game jerseys, team uniform patches, worn helmets, old hockey nets, old hockey sticks, old baseball gloves, old baseball mitts, used golf gloves, used basketballs, used soccer balls, championship soccer balls, used soccer jerseys, used cricket jerseys, used pinnies, foul balls, gym mats, used tennis birdies, used tennis rackets, used saddles, used riding crops, newspapers, game programs, game rules, game scores, limited edition cups, banners, tournament sticks, championship basketballs, used baseball bases, worn baseball jerseys, worn baseball caps, used helmets, used player benches, used buckets, used gum, used soccer nets, used goal nets, used hoops, used boards, used skates, used equipment bags, used goal posts, used cricket balls, used sunglasses, used cricket bats, used swim goggles, used bails, used abdominal protectors, used protective padding, used shin guards, used neck braces, used golf balls, used golf tees, used basketball sneakers, used footwear, used football cleats, used hockey gloves, used hockey masks, used hockey sticks, used skis, used snowboards, used surfboards, used bases, used pucks, metal scrap from race shows, raceway equipment, used shotput, used discs, used weights, used barbells, used whistles, used javelins, used spikes, used cleats, worn swim caps, worn robes, used jackets, used coats, used muffs, used mitts, corner flags, flags, game cards, used towels, used kneepads, used elbow pads, bleachers, used belts, worn volleyballs, water bottles, coolers, worn breastplates, used swim trunks, game plans, old mouthguards, used neck guards, used microphones, used instruments, original drafts and copies of lyrics, scripts, set lists, used costumes, used outfits, used makeup, etc.

Articles may be infixed with minuscule pieces of artifacts such as jerseys, hats, or shavings and pieces of game used equipment such as balls, or they may feature artifacts such as signatures, autographs, tickets, bench shavings, or any desired item or piece that is considered an artifact and can be incorporated into any piece considered an article and create an enhanced article.

In terms of enhanced sporting articles, examples of these artifacts include but are not limited to game used nets, used and or worn sporting equipment, footballs, artificial game turf, stadium pieces, old balls from tournaments, jerseys, helmets, pads, cultural gifts or mementos, and all other game used equipment that can be installed within apparel or other tangible articles such as wearables, memorabilia, and other sporting equipment. The segments, which are to be affixed to an article; thereby making it enhanced, are referenced as artifacts and relate to older, used, real life artifacts from popular culture events. To be installed, they must be fragmented—they are milled and sawed, die cut, laser cut, or just cut to be embedded or affixed to articles. Often these artifacts can prove to be more valuable once they undergo a fragmentation process as they create more supply, and therefore more prospective buyers and traders. Enhanced articles have their own unique serial numbers that correspond with a manufacturing date from when the artifact was cut and developed and what artifacts they contain. They are equipped with a Unique Asset ID (UAID) and sequenced numbers (ex. 43 of 100, or XofX).

In one embodiment, these enhanced articles of sale can include game used equipment such as basketball netting from a championship game, in one embodiment, netting used from championship season may be implemented into a garment or article for enhancement. It may be stitched, sewed, or impressed on with a secure backing or substrate and a corresponding asset ID. The artifact itself may be fragmented in any shape or size and can be integrated into the article in a way that accentuates or follows the articles intended fashion appearance, design features, or by replacing pieces of the original article. Fragments may also be incorporated into the branding of the article. In addition, it may be branded itself as part of the final salable enhanced article.

The artifact is laid and lacerated into the desired number of pieces to prepare for incorporation, with its size depending on the article or unit in which it is positioned into. In terms of manufacturing process, significant to note is an allowance for a cavity that is laser cut to house the artifact and assign an asset ID. In the instance of trading cards, laser cut pieces are referred to as spacers and are made of 1 to 12 pieces of board stock, dependent on the thickness of the piece being inserted. They are printed, foil stamped, and laminated in sheets of traditionally 100 subjects which utilize the same database for cutting the artifact. In the example of more malleable articles, such as clothing, these steps are altered. For example, threads or pieces of a basket's netting may be stitched, altered, or affixed to a backer, to be inserted within an article with a secure backing and a unique code that corresponds with the collated artifact.

In another manifestation of the present invention, the sale article may be footwear. The footwear may adopt pieces from a person of interest's shoe collection, or another artifact of choice. This is typically executed by way of sectioning a piece of game worn equipment or attire, such as a jersey. The sectioned piece can be die cut to form a logo, and then encased. The casing of the logo is composed of an injection molded form and may use thermoplastic polyurethane as the injected material; this is to create a solid case to house the artifact once it has been lacerated into the desired form.

The original authenticated artifact (OAA) or unique original authenticated artifact (UOAA) may be affixed to the footwear in a myriad of ways complimentary to the piece. In some embodiments, a wearer might even be able to customize where the OAA or UOAA is placed alongside other features of the shoe. Since each enhanced article comes with both a unique asset ID and an XofX number, if desired, an entire basketball team may be able to purchase customized basketball shoes bearing a fragment of LeBron James' jersey in each player's shoes.

Be it known, the present invention's encased logo may come in a plurality of manifestations and iterations comprising of the same elements. For example, original authenticated artifact (Object A) may be die cut to the shape of a casing, by way of an adhesive backing. Then, the casing (Object B) is placed over the original authenticated artifact and is machine-stitched to either a shoe's tongue, or the side quarter panel. Then, gold foil stamp with a unique code that corresponds with the database that tracks the die-cut artifact back to the original host artifact. One iteration includes the casing comprising of an open logo so that a wearer may touch the artifact that the casing is affixed to. Another iteration may forgo the logo completely, and instead, just provide an open casing for the housed artifact. By way of example and not limitation, yet another iteration can include an embroidered logo that is die cut to the shape of the casing.

The production process for an enhanced article of sale in the form of footwear comprises of the following steps. Step 1 involves obtaining an authenticated jersey fabric (AJF). Then, the facility determines the location of where the authenticated jersey fabric will be applied on a pair of previously manufactured shoes. The authenticated jersey fabric is then applied on, typically utilizing the brand's logos, in the areas it has been determined to be placed on the shoes by way of an adhesive bond substance or sewn onto the shoe directly. The previous step is then digitally documented with photos or videos to ensure the purchased authenticated jersey fabric is in fact being applied on to the shoes. This digital authentication is stored on the cloud servers. The footwear undergoes pre-packaging product quality assurance checks and then the customized shoes are packaged with all the proof of authenticity documentation in the packaging. Lastly, the footwear is shipped to the purchasing customer.

Each enhanced article has a unique code for each iteration of the cut artifact; also known as an asset ID, which ensures adept tracking of the artifact and its corresponding article. These unique identifiers also disclose which piece of the artifact it contains to track the exact fragment that is ingrained within the enhanced article, a prime feature of origination. The certificates of authenticity, once uploaded to the online database, can assist in the buying, trading, and selling of other enhanced articles among a community of other sports hobbyists with a promise of authenticity and an ability to track and locate the collated artifact among a database.

Each enhanced article or unit comprises of a fraction of the collated artifact and a unique identification number that recognizes its rarity or fraction, for example, it may be one of 100 enhanced articles made, or one of one enhanced article made. These identification numbers are paralleled with the database which contains all authenticated artifacts and are recorded in a manner that ensures security and resistance to fading or tampering.

With each garment equipped with a license and unique asset ID (UAID) and serialized number (XofX) for authentication, consumers are made aware of their product's every move. They can input the serial numbers and asset IDs of their enhanced articles into a global network and view all relevant data regarding their special article, as well as a certificate of authentication.

In another embodiment, a consumer can buy, trade, and sell their enhanced article and may even be able to view others who have registered the same artifact on an online database and marketplace, allowing them to see a collated visual and even locations and other metadata about their purchase. They can also see other consumers' sports artifacts and enhanced articles and their certificates of authenticity, buyer ratings and comments. Each collector, buyer, or fan's profile may contain information such as their preferred or desired teams and figures for trading, previous transactions, pinned enhanced articles, a seller trust rating, and links to other social media.

The platform will allow consumers to engage with one another by bidding on a variety of enhanced articles. In this online marketplace, a collector may choose to put up their enhanced articles for sale. They can provide relevant details such as the amount made and the serial number of their item in order for potential buyers to authenticate their enhanced article using the platform's database. Users may be required to provide the serial numbers and asset IDs for each enhanced article prior to listing to further effectuate authenticity. Users are also required to provide details about the condition of their enhanced articles, as well as photographs of their listed items to ensure full transparency to potential buyers.

The seller will then, in turn, list their artifact and allow potential buyers the opportunity to purchase the item now or bid. Buyers will have the chance to save an item for later and view, in real time, the hikes and drops of prices and may even be able to see the historical and long-term estimates and valuations. In another embodiment, sellers may desire to trade enhanced articles with other enhanced articles. The platform would also offer an option for sellers to compare their enhanced articles with other listings to help them determine their pricing. Ultimately, this decision is still left up to the seller, who may even decide to only accept bids using other enhanced articles or set a minimum for bids and the hours in which bidding can occur.

The platform will also utilize a web service architecture using a standardized XML messaging system, particularly to enable multi-application communications, such as storing and exchanging data. In the preferred embodiment, data is generally related to authenticated artifacts, such as original authenticated artifact pieces and unique original authenticated artifact pieces but also includes supply chain management systems, such as the number of available sales articles. Load balancers can be used to help monitor and guide client requests and data to maximize efficiency on the platform to avoid performance degradation.

In one embodiment, the enhanced article of sale is a non-fungible token on the blockchain. A non-fungible token, or NFT, is a unique unit of data that is stored within the blockchain, or a digital ledger. In accordance with the present invention, the non-fungible token is the enhanced article itself and is listed on the blockchain. Buyers can view the enhanced article's history on the blockchain as a recorded interaction on its digital ledger. Such qualities are valuable for collectors who want to view the cemented history and ownership of an asset, ensure authenticity, receive royalties, as well as accommodate buyers who prefer cryptocurrency to other standard forms of currency.

The present invention solves a long felt need in the sports memorabilia and collecting industries. The present invention makes the sharing of the same artifact of sports history possible, and not just owned by one collector. Rather, the present invention serves as a means of providing accessibility to the historic sports memorabilia market that has not yet been achieved. The present invention allows for multiple owners to each own a portion of the whole of the artifact, thereby introducing fans of sports to an industry that they have previously been financially unable to access. The sports industry is growing at an extreme rate, generating more income, and therefore raising the price for access by its fans. The price for attending events and purchasing memorabilia has grown substantially, but the present invention provides greater means for accessibility of sports' most important artifacts. Many fans only have the means to access their respective sports preferences through their screens from home. The present invention allows those same fans to bring pieces of sports history into their home.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 depicts a championship jersey, worn in competition, which will provide a quantity of artifacts.

FIG. 2 is a depiction of the laceration process for a championship jersey artifact 102 and each piece 202 which will become an artifact portion for embedding into an overall article to form an enhanced article for sale.

FIG. 3 is a closer view of a segment of a championship jersey.

FIG. 4 depicts how the individual segment becomes incorporated into a wearable overall enhanced article.

FIG. 5 is a closer view of the wearable enhanced article with a dotted square representing the artifact's incorporation and certification for the jersey.

FIG. 6 is a depiction of one embodiment of the present invention as a wall-mounted enhanced article, which contains certain artifacts.

FIG. 7 is another embodiment of the present invention with the enhanced article being game equipment, such as a bat, which is affixed to an artifact.

FIG. 8 is a depiction of the present invention on the blockchain.

FIG. 9 shows how certificates of authentication can be sent to a digital network for registry.

FIG. 10 is a flow diagram depicting the chain of events taken between acquiring the Original Authenticated Artifact (OAA) to the final step of selling the New Authenticated Enhanced Article (NAEA), as well as the correlated steps within the Database history.

FIG. 11 depicts a flow diagram of the relationship between the process of becoming an artifact stored in a database with a unique ID, a sales article, and a new authenticated memorabilia artifact/item.

FIG. 12 exhibits an original authenticated artifact, original authenticated artifact piece (OAAP) and unique original authenticated artifact piece (UOAAP), the UAID and XofX number, the sales article, and the signed, new authenticated memorabilia item (NAMBI) and how it relates to a database.

FIG. 13 is an exemplary new authenticated memorabilia item with an enhanced article affixed to it.

FIG. 14 is a diagram depicting the platform's web service infrastructure.

FIG. 15 is a depiction of the platform's web services, as well as the components of an exemplary operating environment in which embodiments of the present invention may be implemented.

FIG. 16 is an illustration of a multi-server room and the various locations in which other pertinent server rooms may exist.

FIG. 17 is a diagram outlining the web services incorporated with server-client communication.

FIG. 18 is a diagram of the flow of access between the platform of the present invention and the web services client via cloud software tools.

FIG. 19 is a diagram of an example of the cloud storage organization in which the web services accesses and retrieves user data as objects in buckets within a cloud storage space.

FIG. 20 is the anatomy of an enhanced article of sale in the form of footwear.

FIG. 21 is a flow diagram of the footwear production process.

FIG. 22 is a depiction of an enhanced article of sale in the form of footwear.

FIG. 23A is one exemplary protective casing of the enhanced article of sale in footwear, wherein the logo is shown.

FIG. 23B is one exemplary open casing of the enhanced article of sale in footwear, wherein the logo has a window for the authenticated article to be felt.

FIG. 23C is another exemplary open casing of the enhanced article of sale in footwear, wherein the logo has a window for the authenticated article to be felt.

FIG. 23D is another exemplary open casing of the enhanced article of sale in footwear, wherein the center has a window for the authenticated article to be felt and a logo.

FIG. 24 is a back view of an exemplary sports jersey, die cut.

FIG. 25 is a depiction of the potentially affixed artifact in the form of a die cut logo made from the previously cut jersey.

### DETAILED DESCRIPTION OF THE PREFERRED EMBODIMENT

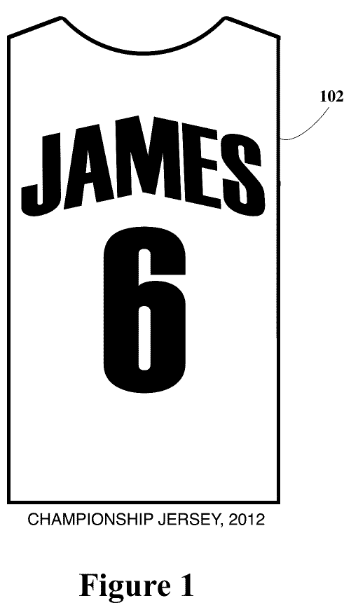

FIG. 1 is a depiction of a championship jersey, which represents an artifact 102.

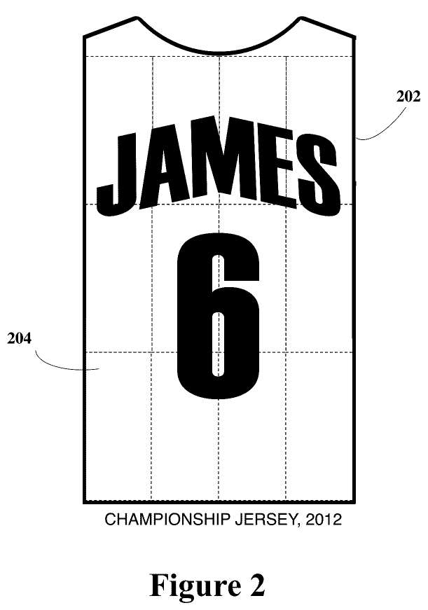

FIG. 2 is a laceration process which consists of cutting an artifact 202 into smaller patches and segments 204.

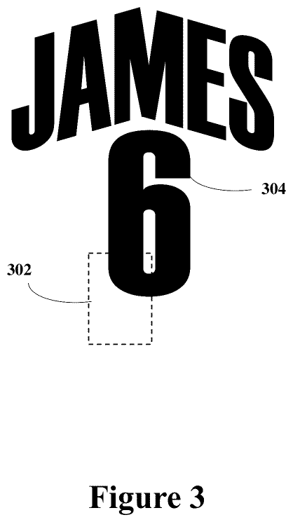

FIG. 3 is a closer view of the cut piece 302 of the artifact 304 which will then be incorporated into different articles of sale.

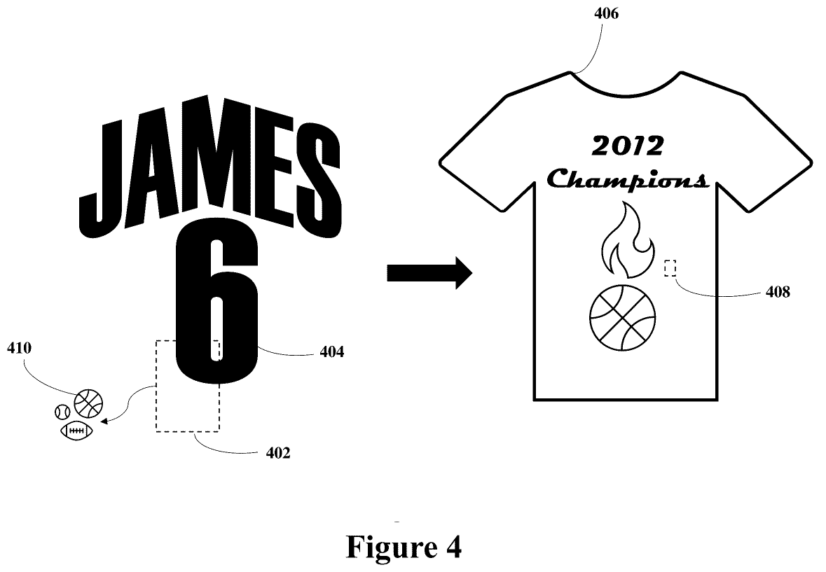

FIG. 4 is an overview of the process which includes cutting up the artifact 404 into minuscule pieces 402 that will be incorporated in a wearable 406 but may also be incorporated into other articles such as sporting equipment 410. The patch of the artifact 408 is depicted on the wearable 406.

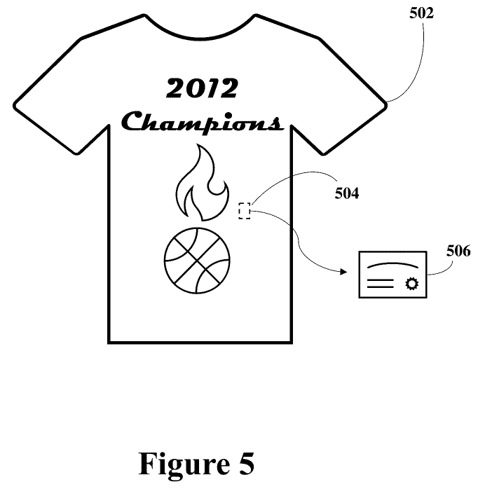

FIG. 5 is another view of the wearable 502 with the infixed artifact 504 thereby turning it into an enhanced article that also has a certificate of authenticity 506.

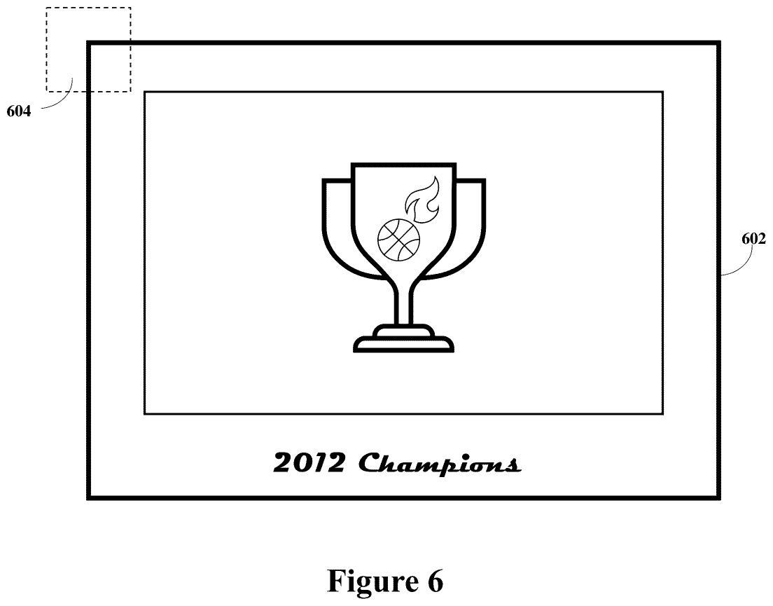

FIG. 6 is the present invention's implementation on a wall-mounted item of memorabilia, such as a championship frame 602. The plaque features an artifact 604 ingrained within the frame, which may be wood from stadium seats, or the basketball court itself.

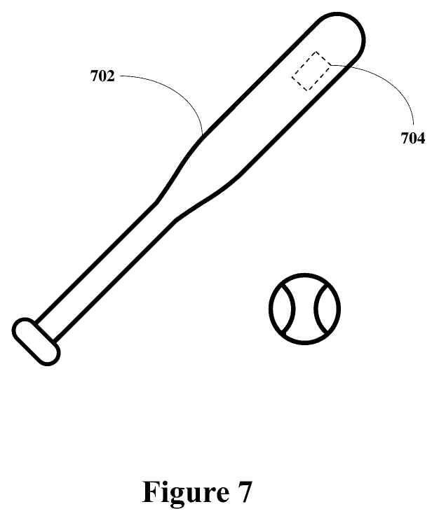

FIG. 7 is another implementation for game equipment 702, in this example, a bat which has an artifact 704 of game used equipment ingrained within.

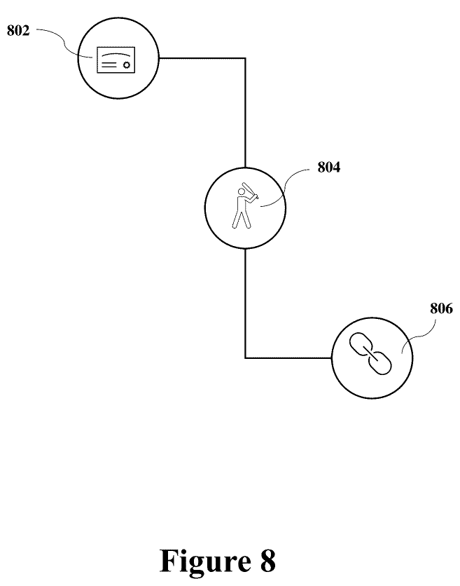

FIG. 8 is a line diagram of certificate of authenticity 802 of an enhanced article 804 which exists as a non-fungible token and displays all interactions on the blockchain 806 in a digital ledger.

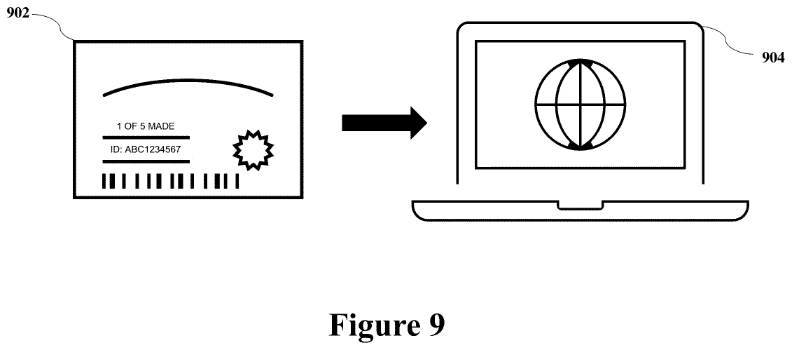

FIG. 9 is another example of a certificate of authenticity 902 being registered on an online database 904 where all pertinent information and data can be viewed regarding their enhanced article.

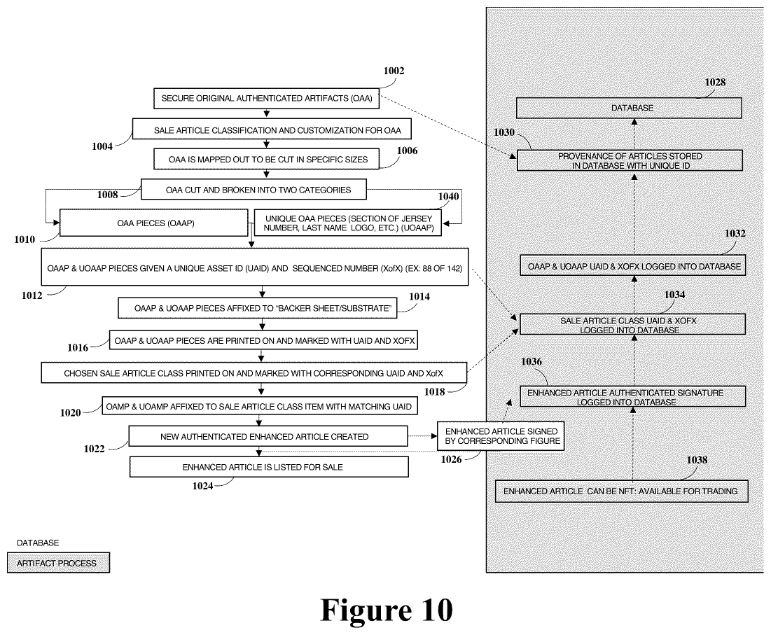

FIG. 10 is a flow diagram depicting the chain of events taken between acquiring the Original Authenticated Artifact (OAA) to the final step of selling the New Authenticated Enhanced Article (NAEA), as well as the correlated steps within the Database history. The original authenticated fragment 1002 comes with a document of the provenance 1028 with a unique ID 1030 which all fragments can be traced back to. These artifacts are assessed distributed among three article classes 1004, one for apparel 1010, another for other artifacts 1040, and a last category for game/used equipment and instruments. The artifact is mapped out 1006 and prepared to be cut 1008 into specific, appropriate sizes, dependent on the article 30 category and size. After fragmentation, the artifacts are cut and broken into two categories—original authenticated artifact pieces (OAAP) 1010 and unique original and authenticated artifact pieces (UOAAP) 1040, which encompass, for example, sections of jersey numbers, last names, logos, and patches, etc. Both categories are assigned unique asset IDs (UAIDs) and sequenced numbers (XofX) which depict what number the fragment is out of the total number of fragments made 1012. To allow affixing or embedding of the artifact into the article, the fragment may be affixed, stitched, attached, etc. to a backer, support, substrate, etc. 1014. The OAAP/UOAAP is then affixed, embedded, attached, etc. to the desired sales article AND marked with the corresponding UAID and XofX number 1016 with the matching UAID 1020. This, in turn, creates a new authenticated article 1022, or the now “enhanced” article. The enhanced article has the UAID 1020 and/or sequenced numbers affixed, embedded, attached, marked, etc. on either the OAAP/UOAAP or article or both. These enhanced articles can be signed or autographed by players, figures, and entertainers. The item is then listed for sale 2016. In the database 1028, each enhanced article is featured with their unique ID 1030. The OAAP and UOAPP UAIDs are logged in 1032 to the database 1036. The enhanced article may also undergo non-fungible tokenization and be available for trading 1038.

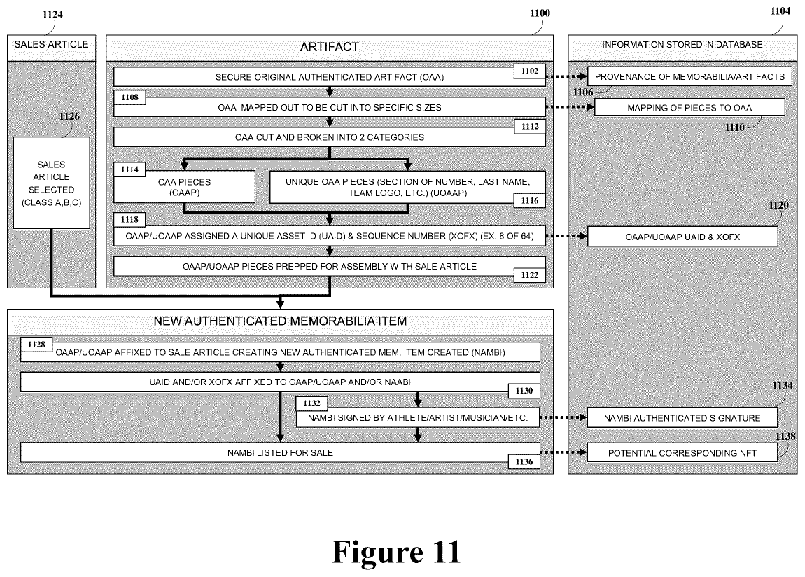

FIG. 11 depicts a flow diagram of the relationship between the process of becoming an artifact 1100. Secure, original authenticated artifacts (OAA) which may also be referred to as memorabilia 1102 are stored in a provenance of memorabilia/artifacts 1106. Original authenticated artifacts 1102 are mapped out, to be cut into specific sized 1108 and the mapping of pieces become fragmented pieces of original authenticated artifacts 1110. These newly fragmented original authenticated artifacts 1112 are cut and broken into two categories, original authenticated artifact pieces 1114 and unique original authenticated artifact pieces (UOAAP) 1116 which, by way of example and not limitation, may comprise of a jersey number, player's last name, team logo, etc. 1116. These pieces are then prepped for assembly with the sale article 1122. The original authenticated artifact pieces and unique original authenticated artifact pieces have a unique asset ID and an XofX number 1120 which distinguish which piece number from the article it contains; for example, piece 1 of 23. The sales article is then assigned a class, such as Class A, B, or C 1126. The item becomes a new authenticated memorabilia item (NAMBI), but it may also be referenced as a new authenticated artifact and item (NAAI) 1128. These artifacts and items are affixed with the original authenticated artifact piece or a unique original authenticated artifact piece and are given a unique asset ID and/or a XofX number 1130. The new authenticated memorabilia item 1128 can also be signed by an athlete, artist, musician, or person of interest 1132 and the signature can be authenticated 1134 and listed for sale 1136; with a potential corresponding non-fungible token or NFT 1138.

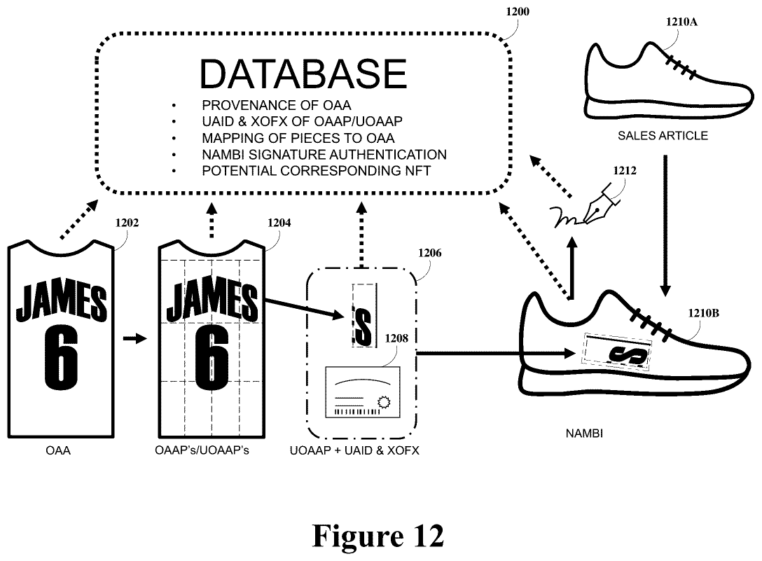

FIG. 12 exhibits the original authenticated artifact 1202 (OAA) and unique original authenticated artifact piece (UOAAP) 1204, the UAID and XofX number 1206 in relation to the OAA 1202 and UOAAP 1204, the sales article 1210A and the signed 1212, new authenticated memorabilia item (NAMBI) 1210. Stored in the database 1200 is the provenance of the original authenticated artifact 1202 and the original authenticated artifact piece 1204, in addition to the unique asset ID and XofX number (e.g., “Piece 1 of 23”) and certifications/IDs 1208. These unique asset ID numbers and XofX numbers correspond directly to the OAA 1202 and OAAP 1204 of the fragmented artifact. The new authenticated memorabilia item 1210B comprises of a sales article 1210A with either an OAA 1202 or an UOAAP 1204 affixed to it, and in some embodiments, an authenticated signature 1212. The database 1200 also features new authenticated memorabilia item 1210B signature authentication 1212 for articles with signatures from pertinent figures and a potential corresponding non-fungible token for the sales article 1210A, 1210B. The solidified arrows represent the process of the creation of the actual NAMBI articles and the dotted arrows represent a relationship between the pieces and the database.

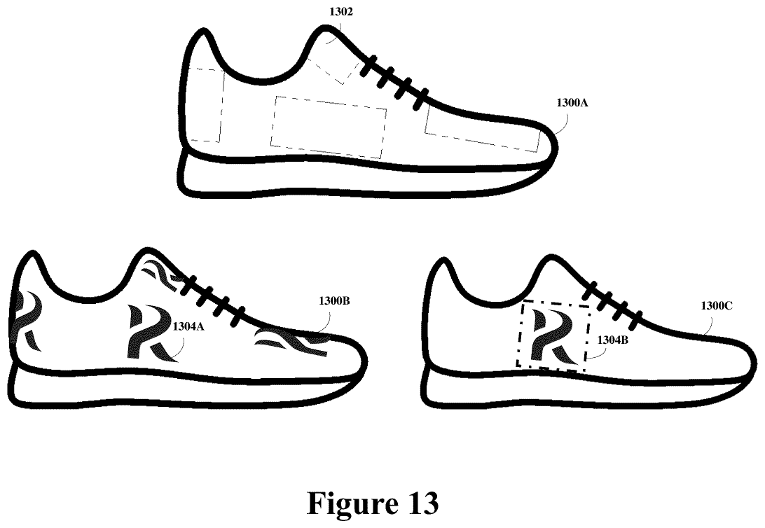

FIG. 13 is an exemplary sales article 1300A and new authenticated memorabilia item 1300B, which may also be referenced as a new authenticated artifact and item 1300B. 1300A represents a sale article, with the dotted rectangles representing 1302 areas in which an original authenticated memorabilia item 1304B may be affixed. In 1300B, a piece from a player's shoe 1304B may be removed and affixed on to a different shoe 1300C in order to create new authenticated memorabilia item 1300C.

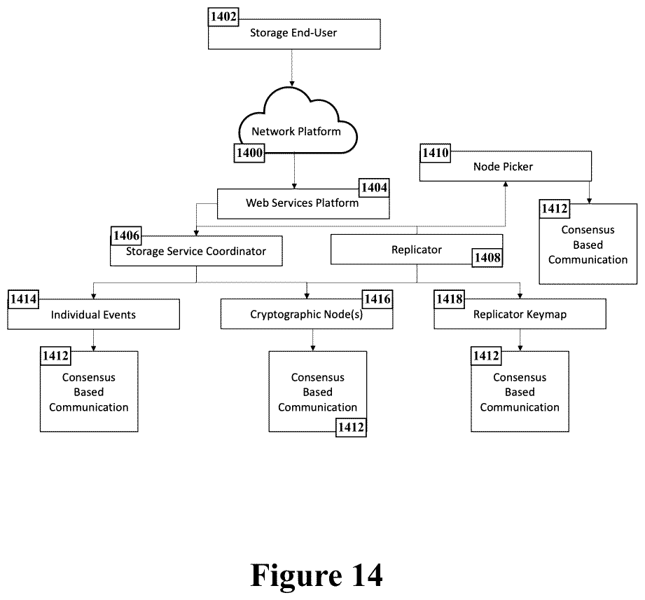

FIG. 14 is a diagram showing the communication between the storage end users 1402, the network platform 1400 and the various elements that help effectuate operations. The storage end user 1402 communicates and relays various pertinent bits of data to the network platform 1400. The network platform 1400 operates on the web service platform 1404, which features a storage service coordinator 1406 and replicator 1408. Each of these services utilize a node picker 1410 which helps establish consensus-based communication 1412. The storage service coordinator 1406 maintains and records individual events 1414 and cryptographic nodes 1416, or keys that are used for operations. The replicator has its own keymap 1418 which generates consensus-based communication 1412, alongside the cryptographic nodes 1416 and individual events 1414.

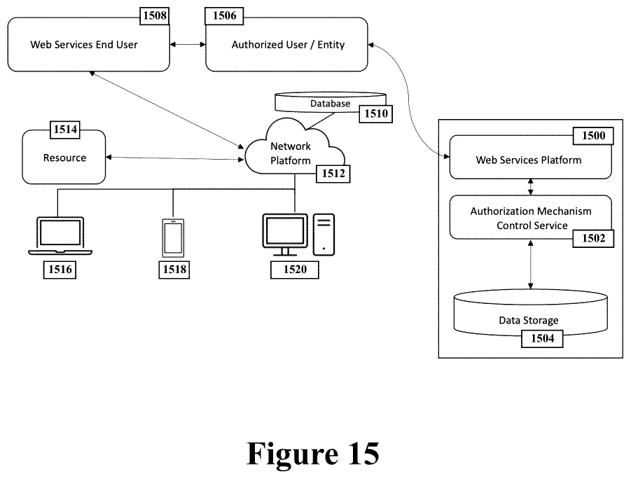

FIG. 15 is a diagram showing the web services of the platform and system. The platform and system are all components of an exemplary operating environment in which embodiments of the present invention may be implemented. The system can include one or more user computers, computing devices, or processing devices which can be used to operate a client, such as a dedicated application, web browser, etc. The user computers can be general purpose personal computers (including, merely by way of example, personal computers and/or laptop computers 1516 running a standard operating system), cell phones or PDAs 1518 (running mobile software and being Internet, e-mail, SMS, Blackberry, or other communication protocol enabled), and/or workstation computers 1520 running any of a variety of commercially-available UNIX or UNIX-like operating systems (including without limitation, the variety of GNU/Linux operating systems). These user computers may also have any of a variety of applications, including one or more development systems, database client and/or server applications, and Web browser applications. Alternatively, the user computers may be any other electronic device, such as a thin-client computer, Internet-enabled gaming system, and/or personal messaging device, capable of communicating via a network (e.g., the network described below) and/or displaying and navigating Web pages or other types of electronic documents. Although the exemplary system is shown with four user computers, any number of user computers may be supported.

In most embodiments, the system includes some type of network. The network can be any type of network familiar to those skilled in the art that can support data communications using any of a variety of commercially available protocols, including without limitation TCP/IP, SNA, IPX, AppleTalk, and the like. Merely by way of example, the network can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, WiMAX, WiFi, CDMA 2000, WCDMA, the Bluetooth protocol known in the art, and/or any other wireless protocol); and/or any combination of these and/or other networks.

The system may also include one or more server computers which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers may be dedicated to running applications, such as a business application, a Web server, application server, etc. Such servers may be used to process requests from user computers. The applications can also include any number of applications for controlling access to resources 1514 of the servers.

The web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers. As one example, a server may execute one or more Web applications. The Web application may be implemented as one or more scripts or programs written in any programming language, such as Java®, C, C #, or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer.

End users 1508, or users that are viewing and using the network platform 1512, all contribute data to the cloud. A web service platform 1500 helps secure that data and maintain the service's functionalities. Only authorized users and entities 1506 can authorize or unauthorize content and monitor data stored within the web service. The platform's web services 1500 help maintain the operations of elements through the authorization mechanism control service 1502 managed by the data storage system 1504.

The system may also include one or more databases 1510. The database(s) 1510 may reside in a variety of locations. By way of example, a database 1510 may reside on a storage medium local to (and/or resident in) one or more of the computers 1520. Alternatively, it may be remote from any or all of the computers, and/or in communication (e.g., via the network) with one or more of these. In a particular set of embodiments, the database may reside in a storage-area network (“SAN”) familiar to those skilled in the art. Similarly, any necessary files for performing the functions attributed to the computers may be stored locally on the respective computer and/or remotely, as appropriate. In one set of embodiments, the database may be a relational database, such as Oracle 10g, that is adapted to store, update, and retrieve data in response to SQL-formatted commands.

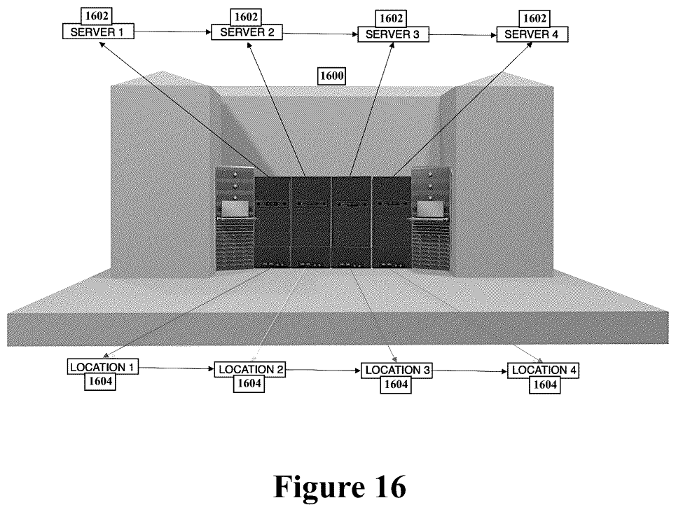

FIG. 16 is an illustration of server-to-server connections 1602, within a server room 1600 and to other server room locations 1604. The web server undergoes an initialization process and features a database of wireless network data. Dependent on the service requested, the data may undergo processing. The servers 1602 actively attempt to retrieve the appropriate data to provide user input. Data may then be formatted, and with the appropriate authorizations, saved or restructured.

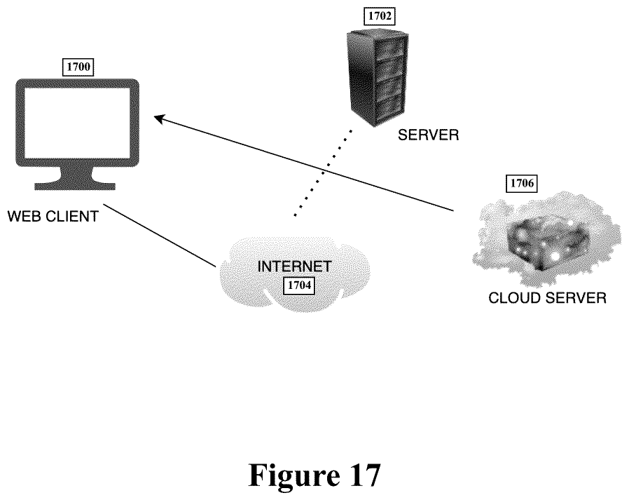

FIG. 17 is a diagram outlining the role of web services in the present invention. In accordance with the preferred embodiment, a web client 1700 interacts with the server ecosystem 1702 by way of a service connection, such as the internet 1704, which then distributes data and pertinent information such as the web service platform to the cloud server 1706 and preliminary servers. This allows for data to be streamlined between the client 1700 and the server 1702 as well as cloud servers 1706 and other database systems. Communication between web services may be completed via Simple Object Access Protocol (SOAP) which allows multiple web service applications to communicate rapidly and efficiently and to provide data to the web client.

The infrastructure of the present invention also allows for the use of web services that enable interaction with and storage of data across devices. Specifically, these web services can allow for the use of cloud software tools and cloud-based data storage. Cloud software tools can be used to allow for increased user authentication and authorization checkpoints for data accessed between parties. The web service software aids in the transmission of data between entities while still maintaining secure access restrictions preventing any unauthorized access to the cloud data.

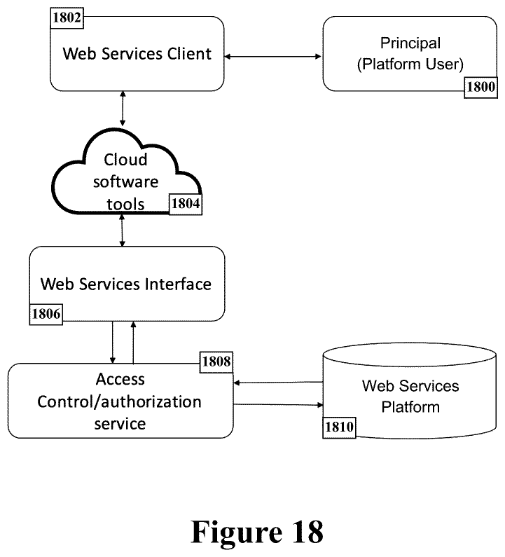

FIG. 18 is a diagram of the flow of access between the platform of the present invention and the web services client via cloud software tools. The principal or platform user 1800 accesses the web services client 1802, which then transmits data via cloud software tools 1804 to the web services interface 1806. Access control and authorization 1808 acts as a layer in order to access the web services platform 1810 by way of the web services interface 1806.

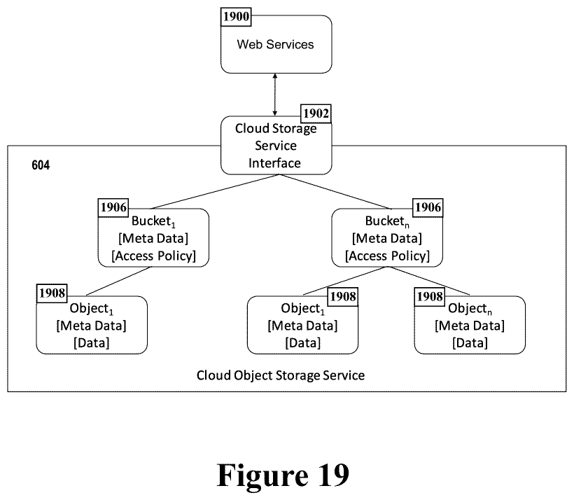

FIG. 19 is a diagram of an example of the cloud storage organization in which the web services 1900 accesses and retrieves user data as objects 1908 in buckets 1906 within a cloud storage space 1904. The cloud storage 1904 service is a means of storing and protecting any amount of data for a range of use cases. A bucket 1906 is a container for objects stored in the cloud storage service 1904, and objects 1908 consist of object data and metadata. The metadata is a set of name-value pairs that describe the object. These pairs include some default metadata, such as the date last modified, and standard HTTP metadata, such as Content-Type. You can also specify custom metadata at the time that the object is stored. Web services 1900 provide access to and from the cloud object storage service 1904 via the cloud storage service interface 1902.

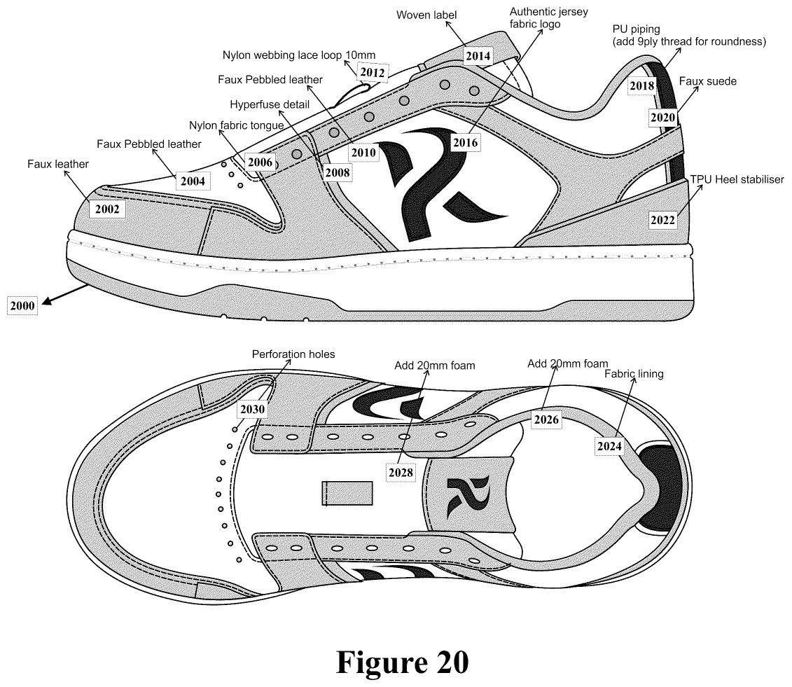

FIG. 20 is a depiction of the enhanced article of sale. In this example, it's footwear. The enhanced article of sale, or shoe, 2000 comprises of faux leather 2002 for most of the construction's base and faux pebbled leather 2004 around the toe box. Around the toe box there are also perforation holes 2030 to give the toes some more room and air to breathe. The shoe 2000 also has a nylon fabric tongue 2006 and webbing lace loops 2012. There is also faux pebbled leather 2010 located at the center of the shoe where the authentic jersey fabric logo 2016 is situated. The faux pebbled leather 2010 is adorned by hyperfused detail 2009 and near the heel of the shoe is PU piping 2018 and faux suede 2020. At the heel there is also a TPU heel stabilizer 2022. Around the ankle area of the shoe 2000 is fabric lining 2024 and foam 2026 which is also featured underneath the laces 2028.

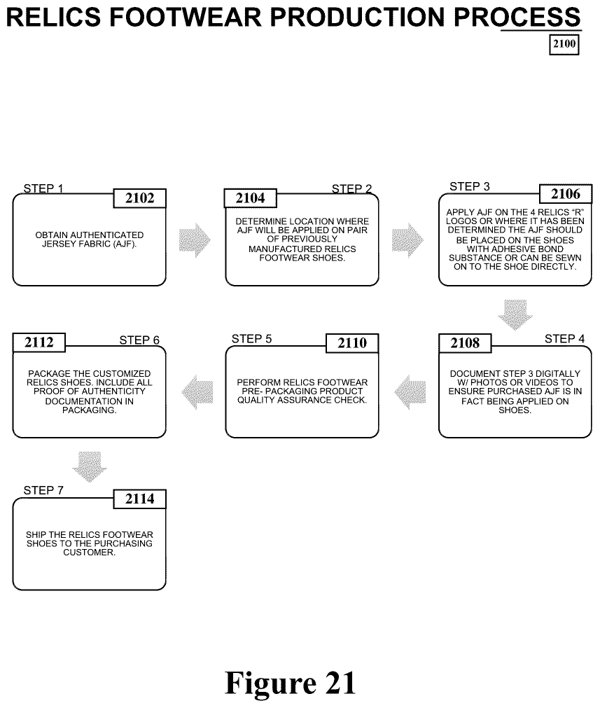

FIG. 21 is the production process for an enhanced article of sale in the form of footwear 2100. Step 1 comprises of obtaining an authenticated jersey fabric (AJF) 2102. Then, the facility determines the location of where the authenticated jersey fabric will be applied on a pair of previously manufactured shoes 2104. The authenticated jersey fabric is then applied on, typically utilizing the brand's logos, in the areas it has been determined to be placed on the shoes by way of an adhesive bond substance or sewn on to the shoe directly 2106. The previous step is then digitally documented with photos or videos to ensure the purchased authenticated jersey fabric is in fact being applied on to the shoes 2108. The footwear undergoes pre-packaging product quality assurance checks 2110 and then the customized shoes are packaged with all the proof of authenticity documentation in the packaging 2112. Lastly, the footwear is shipped to the purchasing customer 2114.

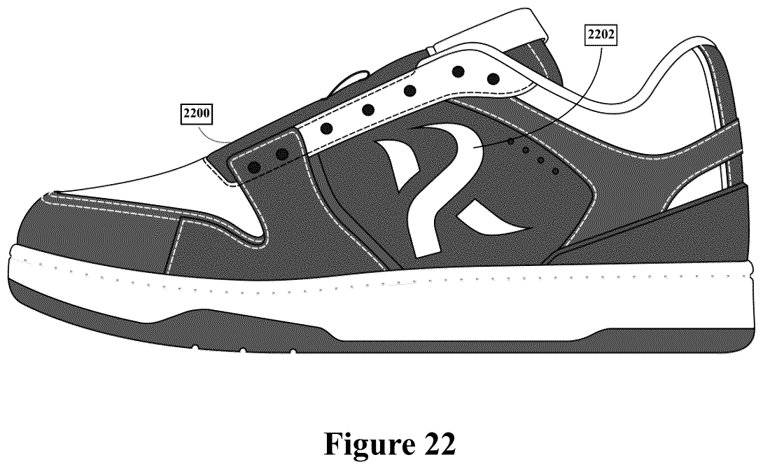

FIG. 22 is an exemplary depiction of what an enhanced article of sale looks like in the form of footwear. The shoe 2200 features the Relic logo 2202 which consists of authenticated jersey fabric (AFJ). The shoe 2200 may come in a variety of different colorways.

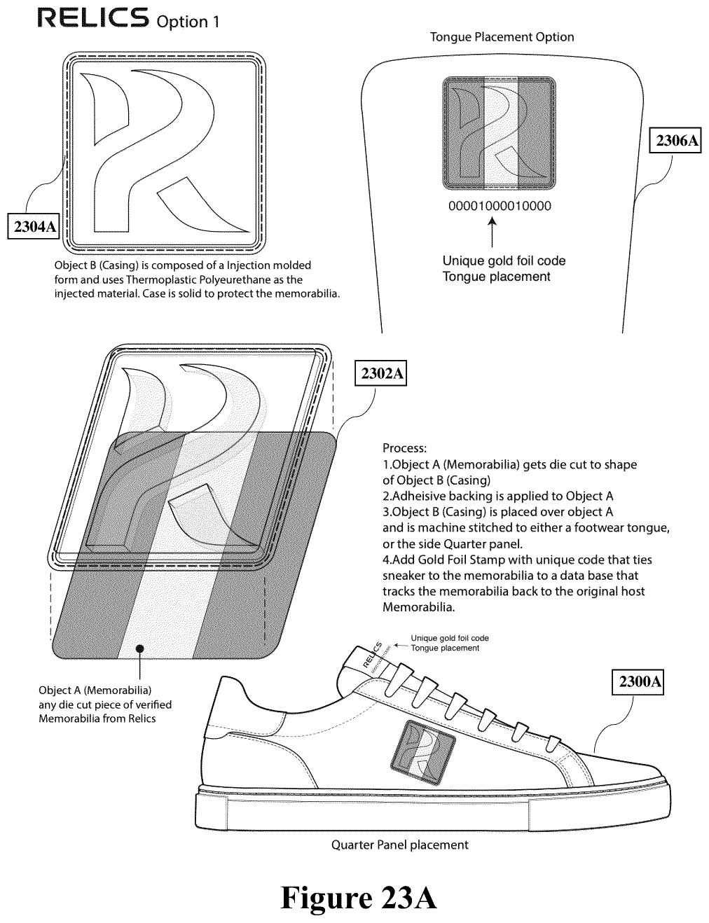

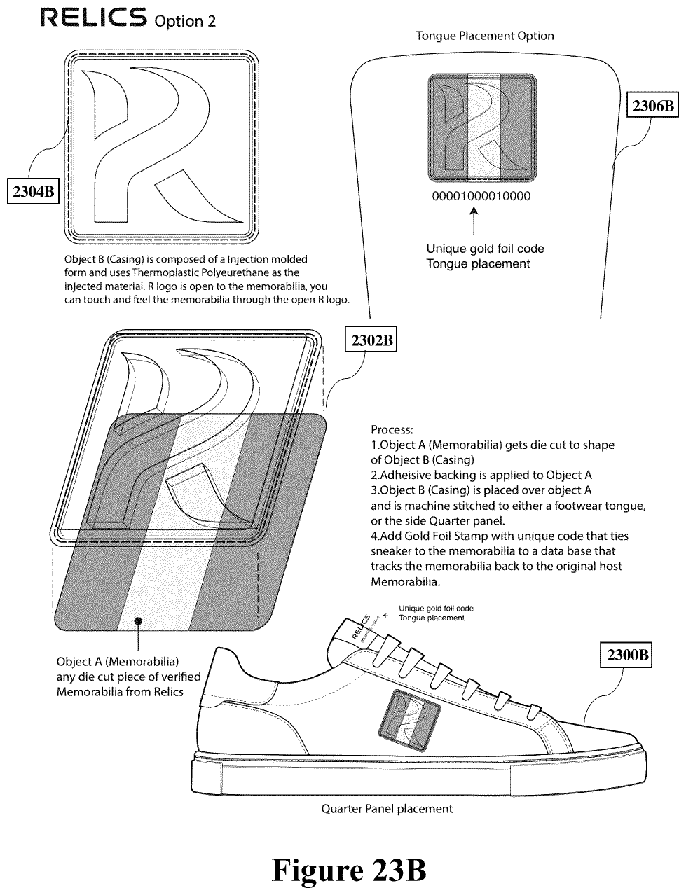

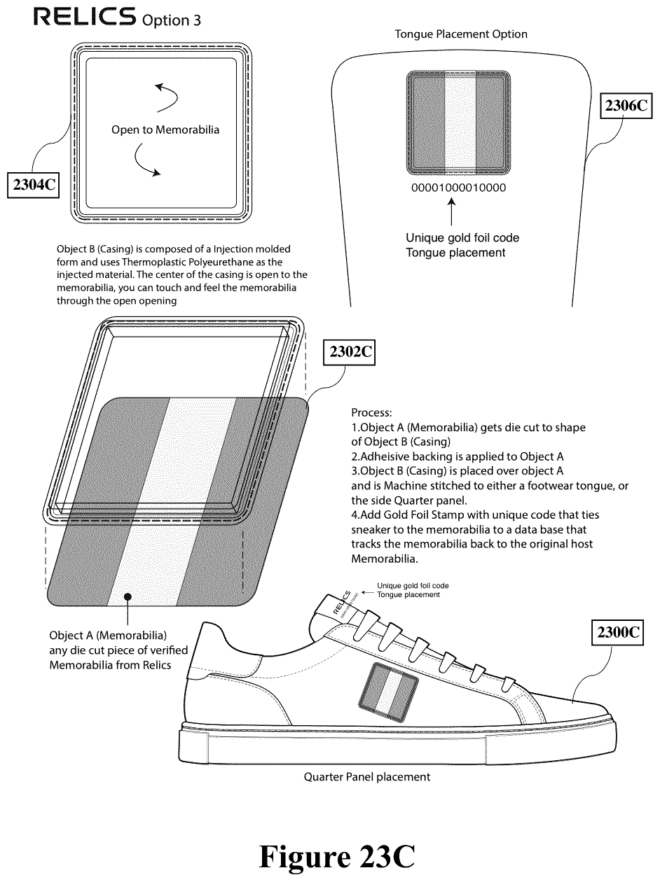

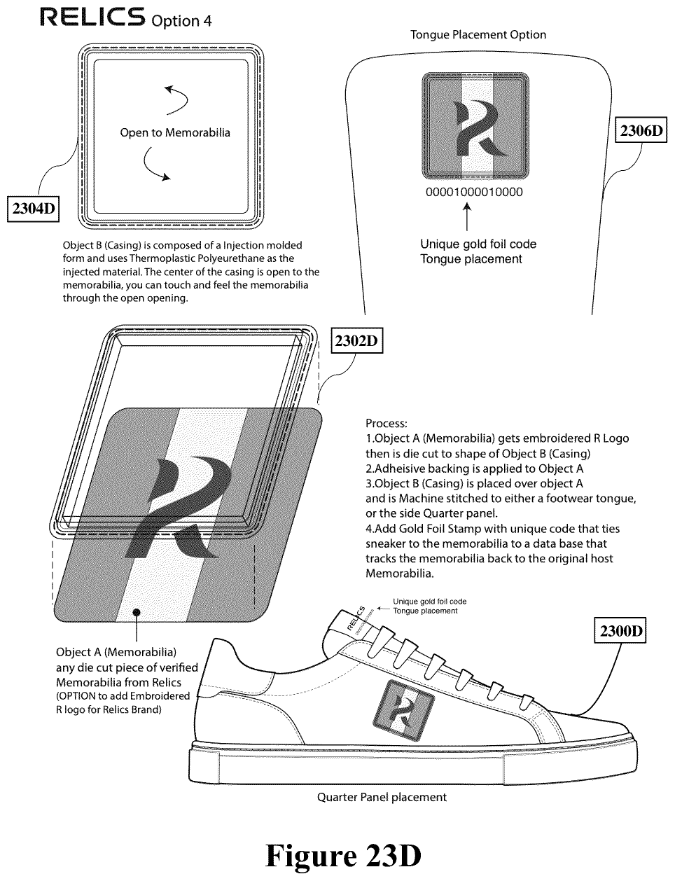

FIG. 23A is one exemplary protective casing of the enhanced article of sale in footwear, wherein the logo is shown. In this embodiment, the shoe 2300A features a piece of memorabilia or an authenticated artifact (Object A) 2302A encased in an injection molded form or case (Object B) 2304A which uses thermoplastic polyurethane as the injected material. This ultimately ensures the artifact or memorabilia 2302A is protected within the case. The encased artifact 2304A in this example is placed at the quarter panel of the shoe 2300A. The tongue of the shoe 2300A also features a unique gold foil code housing the corresponding UAID 2306A.

FIG. 23B is one exemplary open casing of the enhanced article of sale in footwear, wherein the logo has a window for the authenticated article to be felt. In this embodiment, the shoe 2300B features a piece of memorabilia or an authenticated artifact (Object A) 2302B encased in an injection molded form or case (Object B) 2304B which uses thermoplastic polyurethane as the injected material with an open window/logo to allow the housed artifact to be felt. The encased artifact 2304B in this example is placed at the quarter panel of the shoe 2300B. The tongue of the shoe 2300B also features a unique gold foil code housing the corresponding UAID 2306B.

FIG. 23C is another exemplary open casing of the enhanced article of sale in footwear. In this embodiment, the shoe 2300C features a piece of memorabilia or an authenticated artifact (Object A) 2302C encased in an injection molded form or case (Object B) 2304C which uses thermoplastic polyurethane as the injected material. The center of the casing 2304C is open so the artifact can be touched and felt through the window. The encased artifact 2304C in this example is placed at the quarter panel of the shoe 2300C. The tongue of the shoe 2300C also features a unique gold foil code housing the corresponding UAID 2306C.

FIG. 23D is another exemplary open casing of the enhanced article of sale in footwear, wherein the center has a window for the authenticated article to be felt and a logo. In this embodiment, the shoe 2300D features a piece of memorabilia or an authenticated artifact (Object A) 2302D encased in an injection molded form or case (Object B) 2304D which uses thermoplastic polyurethane as the injected material. The encased artifact 2304D in this example is placed at the quarter panel of the shoe 2300D. The center of the casing 2304D is open so the artifact can be touched through the window. The tongue of the shoe 2300D also features a unique gold foil code housing the corresponding UAID 2306D. This embodiment may feature an embroidered logo for the enhanced article.

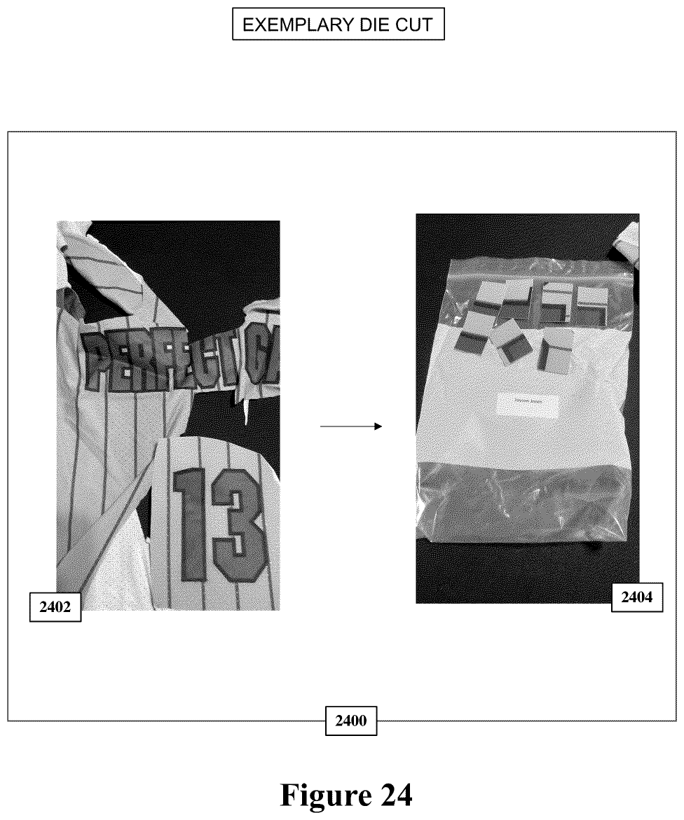

FIG. 24 is an exemplary die cut jersey 2404 or authenticated artifact 2404, which is the authenticated jersey 2402. The jersey 2402 now die cut 2404 is displayed to the right. The cut pieces will constitute as an artifact that will be affixed to various apparel and items.

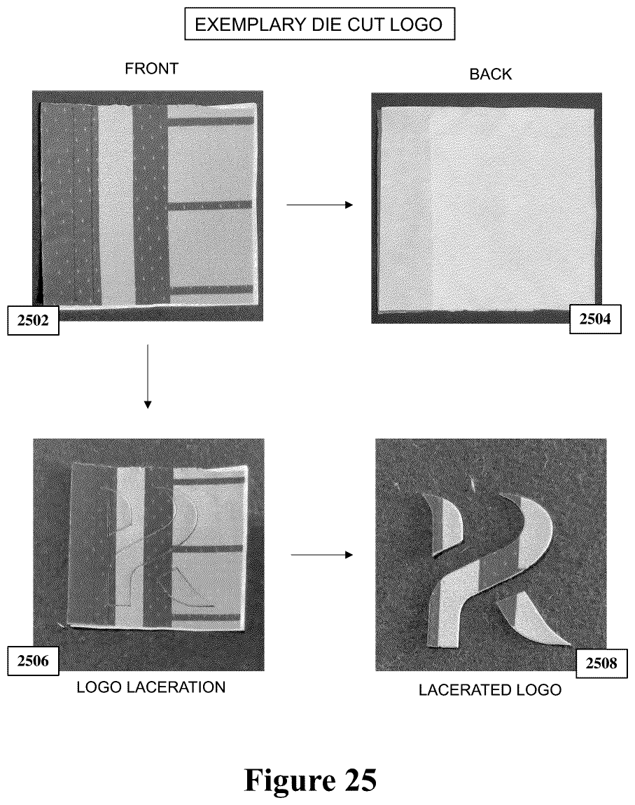

FIG. 25 is an exemplary die cut logo using the previous jersey. The cut, squared jersey 2502 front can be viewed alongside the jersey back 2504. The logo laceration 2506 can be seen. Once excess fabric is removed, the result is a newly lacerated logo 2508.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical, or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A cloud storage organization system with user data pertaining to the serial numbers assigned to enhanced articles and for maintaining and storing cloud data regarding said serial numbers and unique asset IDs of said enhanced articles of sale over a web service, processing data and retrieving data to provide user input by way of a server, utilizing cloud software tools and cloud-based data storage tools for user and asset authentication for allowing consumers to engage with one another by bidding on a variety of enhanced articles in an online marketplace, wherein a collector may choose to put up their enhanced articles for sale and provide relevant details including the amount made and the serial number of their item in order for potential buyers to authenticate their enhanced article using the platform's database, and utilizing load balancers to monitor and guide client requests across backend servers.

2. A cloud storage organization system according to claim 1 wherein the users may be required to provide the serial numbers and the asset IDs for each enhanced article prior to listing to further effectuate authenticity and wherein said users are also required to provide details about the condition of their enhanced articles, as well as photographs of their listed items to ensure full transparency to potential buyers.

3. A cloud storage organization system according to claim 2 wherein wearables are infused with artifacts.

4. A cloud storage organization system according to claim 3 wherein said wearables are footwear.

5. A cloud storage organization system according to claim 2 wherein memorabilia is infused with artifacts.

6. A cloud storage organization system according to claim 2 wherein game devices or instruments are infused with artifacts.

7. A cloud storage organization system according to claim 2 wherein footwear is infused with artifacts to form usable memorabilia.

8. A method of selling articles infused with artifacts with associated serial numbers assigned to enhanced articles and for maintaining unique asset IDs of said enhanced articles of sale to distribute to consumers with user and asset authentication to allow said consumers to engage with one another by bidding on a variety of said enhanced articles in a marketplace, and wherein a collector may choose to auction said enhanced articles of sale and provide relevant details including the number made in order for potential buyers to authenticate said enhanced article.

9. A method according to claim 8 of selling articles infused with artifacts wherein said users are required to provide details about the condition of their enhanced articles as well as photographs of their listed items to ensure full transparency to potential consumers.

10. A method according to claim 9 of selling articles infused with artifacts wherein said articles are footwear.

11. A method according to claim 10 wherein information about said footwear includes the condition of said footwear and includes a serial number associated with said footwear.

12. A method according to claim 9 of selling articles infused with artifacts wherein said articles are caps.

13. A method according to claim 12 wherein information about said cap includes a condition of said cap and a serial number associated with said cap.

14. A method according to claim 8 of selling articles infused with artifacts by using a cloud storage organization system wherein said cloud system stores and distributes information associated with said articles wherein said information includes both condition data and serial number data associated with said articles.

15. A method of selling articles infused with artifacts to consumers by using a cloud storage organization system with user data pertaining to the serial numbers assigned to enhanced articles and for maintaining and storing cloud data regarding said serial numbers and unique asset ids of said enhanced articles of sale over a web service, processing data and retrieving data to provide user input by way of a server, utilizing cloud software tools and cloud-based data storage tools for user and asset authentication for allowing consumers to engage with one another by bidding on a variety of enhanced articles in an online marketplace, wherein a collector may choose to put up their enhanced articles for sale and provide relevant details including the amount made and the serial number of their item in order for potential buyers to authenticate their enhanced article using the platform's database.

16. A method according to claim 15 of selling articles infused with artifacts to consumers by using a cloud storage organization system wherein the users may be required to provide the serial numbers and the asset IDs for each enhanced article prior to listing to further effectuate authenticity and said users are also required to provide details about the condition of their enhanced articles, as well as photographs of their listed items to ensure full transparency to potential buyer.

17. A method according to claim 16 of selling articles infused with artifacts by using a cloud storage organization system.

18. A method according to claim 15 of selling articles infused with artifacts by using a cloud storage organization system wherein said wearables are footwear.

19. A method according to claim 15 of selling articles infused with artifacts by using a cloud storage organization system wherein memorabilia is infused with artifacts.

20. A method according to claim 15 of selling articles infused with artifacts by using a cloud storage organization system wherein game devices or instruments are infused with artifacts.

21. A method according to claim 15 of selling articles infused with artifacts by using a cloud storage organization system wherein footwear is infused with artifacts to form usable memorabilia.
